(19) United States
(12) Patent Application Publication
(10) Pub. No.: US 2009/0095224 A1
(43) Pub. Date: Apr. 16, 2009

(54) PET POTTY DISPOSAL PAPER

(76) Inventor: JOYCE COOPER, CLEARWATER, FL (US)

Correspondence Address: DENNIS G. LAPOINTE;LAPOINTE LAW GROUP, PL, PO BOX 1294, TARPON SPRINGS, FL, 34688-1294, US

(21) Appl. No.: 11/872,294

(22) Filed: Oct. 15, 2007

(51) Int. Cl. A01K 29/00

(52) U.S. Cl. 119/161

(57) ABSTRACT

A dog bowel movement retrieval device comprising a generally planar bowel retrieval member that can be placed on the ground and is made from a flexible paper based material. The device has a predetermined generally centrally located portion bounded by a perimeter portion on which a layer of adhesive is located on desired parts of the perimeter portion of the member. The adhesive is temporarily protected by an adhesive release material, which is in an overlying relationship with the adhesive. When in use, the centrally located portion is the area on which a dog would excrete its bowel movement droppings, and the device is bawled up so that the adhesive sticks together to secure the bowel movement droppings for its disposal in a sanitary manner. Preferably, the paper-based material is biodegradable.

### FIELD OF THE INVENTION

The invention relates to an apparatus for use in the retrieval and disposing of pet bowel movements when walking the pet.

### BACKGROUND OF THE INVENTION

Pet owners typically walk their dogs and use plastic bags as reversible sleeve with a hand inside the bag. The bowel movement is retrieved with the hand inside the bag and the bag is turned inside out. The bag is then disposed of in the garbage container. Others have used more complex devices such as a shovel with a bag attached to the end of the shovel to retrieve the bowel movement. Both methods are messy and potentially unsanitary if the bag has a hole in it or hand contact is made with the dog waste product.

### SUMMARY OF THE INVENTION

The present invention overcomes the aforementioned shortcomings. It is a potty paper made from bio-degradable paper material. It can be shaped in desired dimensional shapes such as circular, square or rectangular, and can be made in various sizes (such as small, medium and large) to accommodate the size of the dog being walked. In a preferred embodiment, the invention comprises a laminate or generally planar bowel retrieval member that can be placed on the ground and is made from a flexible, preferably biodegradable, paper based material.

The invention has a designated or predetermined generally centrally located portion, which is the area on which a dog would have his bowel movement dropping. This centrally located portion would be bounded by a perimeter portion on which a layer of adhesive is located. The adhesive can be applied to the complete area of the perimeter portion or can be applied to parts or portions of the perimeter area. The adhesive would be protected with a releasable film or release paper. The adhesive applied and release material could be similar to those materials used on self-sealing envelopes or on bandage strips.

When in use, the invention can be in a folded state for ease of carrying in a bag or purse or other container. It then is unfolded and placed on the ground surface underneath the dog. The strip of release paper can be removed prior to or after the dog has had its bowel movement. In any event, after the dog has excreted onto the central area of the invention, the bowel retrieval member is bawled up so that the glue/adhesive sticks together to secure the bowel movement droppings so the dog excreted waste can be properly disposed of in a sanitary manner in a garbage container.

Certainly, if the paper is bio-degradable, it may even be disposable directly into a sewage system, if applicable.

### BRIEF DESCRIPTION OF THE DRAWINGS

In the accompanying drawing:

FIG. 1 is a conceptual representation of an example of an embodiment of the invention.

### DETAILED DESCRIPTION OF THE INVENTION

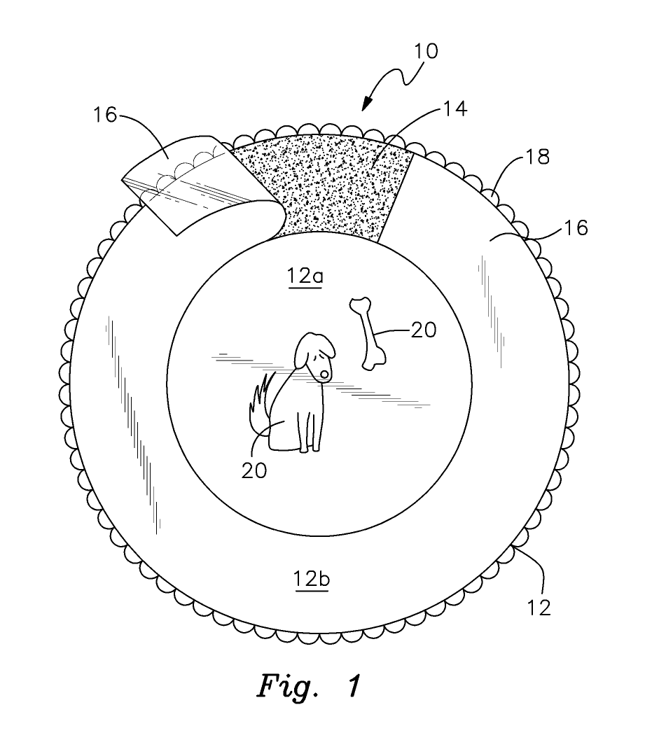

Referring now to the drawing, FIG. 1 is a conceptual representation of an example of an embodiment of the invention, which is a dog bowel movement retrieval device and is depicted generally as 10.

The dog bowel movement retrieval device 10 comprises a generally planar bowel retrieval member 12 that can be placed on the ground and is made from a flexible material. The member 12 has a predetermined generally centrally located portion 12a bounded by a perimeter portion 12b on which a layer of adhesive 14 is located on desired parts of the perimeter portion 12b of member 12. The adhesive 14 is preferably located over the entire surface of the perimeter portion 12b. Alternatively, the adhesive may be widely distributed on parts of the perimeter portion 12b. In addition, the adhesive 14 applied and release material 16 could be similar to material that is used on self-sealing envelopes or on bandage strips. Such materials are readily commercially available.

The perimeter portion 12b may be wide or relatively thin as compared to the overall size of the device 10 and its central portion 12a, however the width must be sufficient to adequately adhesively secure the contents of the device 10 when bawled up after a dog has excreted on the device 10.

The adhesive 14 is temporarily protected by an adhesive release material 16, which is in an overlying relationship with the adhesive 14.

A dog would excrete its bowel movement droppings on the centrally located portion 12a.

After the dog has excreted onto the centrally located portion 12a, the device 10 is bawled up so that the adhesive sticks together to secure the bowel movement droppings for its disposal in a sanitary manner.

The generally planar bowel movement retrieval member 12 is preferably made from a paper-based, bio-degradable material.

In one embodiment, the invention includes a decorative edging 18 around an outer edge of the device. This edging can be scalloped as shown in the drawing. Further, desired indicia in the form of graphics and/or texts 20 may be located or printed in the central portion 12a.

The device 10 can be shaped in desired dimensional shapes such as circular, square or rectangular, and can be made in various sizes (such as small, medium and large) to accommodate the size of the dog being walked.

It should be understood that the preceding is merely a detailed description of one or more embodiments of this invention and that numerous changes to the disclosed embodiments can be made in accordance with the disclosure herein without departing from the spirit and scope of the invention. The preceding description, therefore, is not meant to limit the scope of the invention. Rather, the scope of the invention is to be determined only by the appended claims and their equivalents.

What is claimed is:

1. A dog bowel movement retrieval device comprising:
a generally planar bowel retrieval member that can be placed on the ground and is made from a flexible material;
said member having a predetermined generally centrally located portion bounded by a perimeter portion on which a layer of adhesive is located on desired parts of said perimeter portion of said member; and
said adhesive being temporarily protected by an adhesive release material, which is in an overlying relationship with said adhesive,
wherein said centrally located portion is the area on which a dog would excrete its bowel movement droppings, and
wherein after the dog has excreted onto said centrally located portion, the device is bawled up so that said adhesive sticks together to secure said bowel movement droppings for its disposal in a sanitary manner.

2. The device according to claim 1, wherein the generally planar bowel movement retrieval member is made from a paper-based material.

3. The device according to claim 1, further comprising a decorative edging around an outer edge of said device.
